(19) United States
(12) Patent Application Publication
(10) Pub. No.: US 2026/0012040 A1
(43) Pub. Date: Jan. 8, 2026

(54) WIRELESS POWER TRANSMISSION COIL, COIL ASSEMBLY, AND ELECTRONIC DEVICE

(71) Applicant: Lanto Electronic Limited, Kunshan City (CN)

(72) Inventors: Bang Liang, Kunshan City (CN); LieFeng Jin, Kunshan City (CN)

(73) Assignee: Lanto Electronic Limited, Kunshan City (CN)

(21) Appl. No.: 19/258,196

(22) Filed: Jul. 2, 2025

(30) Foreign Application Priority Data
Jul. 8, 2024 (CN) 202410909980.0

(51) Int. Cl. H02J 50/00; H01F 27/28; H02J 50/10

(52) U.S. Cl. CPC H02J 50/005; H01F 27/2823; H01F 27/2871; H02J 50/10

(57) ABSTRACT

A wireless power transmission coil, a coil assembly, and an electronic device are disclosed. By dividing the continuously wound wireless power transmission coil into a first section and a second section arranged along the circumferential direction, and employing different winding methods in the first and second sections, the first section has a first maximum thickness, and the second section has a second maximum thickness that greater than the first maximum thickness. From the outer edge to the inner edge, the first section has a first width, and the second section has a second width that is less than the first width. This allows the dimensions of the wireless power transmission coil to be adjusted to fit the space constraints within the electronic device while ensuring that the area of the wireless power transmission coil is not excessively reduced, thereby maintaining the charging efficiency of wireless charging.

### CLAIM OF PRIORITY AND CROSS-REFERENCE TO RELATED APPLICATION

This application claims the benefit of Chinese Patent Application No. 202410909980.0, filed on Jul. 8, 2024, which is incorporated herein by reference in its entirety.

### BACKGROUND

### 1. Field of the Invention

The present invention relates to the field of wireless charging technology, and particularly to a wireless power transmission coil, a coil assembly, and an electronic device.

### 2. Description of the Related Art

In recent years, with the increasing maturity of wireless power transmission technology, more and more electronic devices have incorporated wireless charging capabilities, thereby enhancing the flexibility of charging. A power transmission coil is a critical component in wireless charging systems. For example, in the widely used electromagnetic induction-based wireless charging system, an alternating current of a specific frequency is supplied to the transmitter coil at the power transmitter end. Through electromagnetic induction, this induces a corresponding current in the receiver coil at the power receiver end, thereby transferring energy from the power transmitter end to the power receiver end.

With the increasing demands for miniaturization and compactness of electronic devices, the available space within electronic devices for accommodating wireless power transmission coils has become more limited, and this presents challenges for the placement of wireless power transmission coils.

### SUMMARY

In view of this, an embodiment of the present disclosure provides a wireless power transmission coil, a coil assembly, and an electronic device that may be conducive to fully utilizing the space within the electronic device while ensuring the charging efficiency of wireless charging.

In the first aspect, the present disclosure provides a wireless power transmission coil. The wireless power transmission coil is continuously wound from a conductor in a first winding direction. The wireless power transmission coil includes a first section and a second section arranged along the circumferential direction. The first section has a first maximum thickness, and the second section has a second maximum thickness. The first section has a first width from the outer edge to the inner edge, and the second section has a second width from the outer edge to the inner edge. The second maximum thickness is greater than the first maximum thickness, and the second width is less than the first width.

In the second aspect, the present disclosure further provides a coil assembly, comprising: the wireless power transmission coil according to the first aspect, wherein the conductor of the wireless power transmission coil has an inner end and an outer end; and a connection circuit board, located on one side of the wireless power transmission coil and respectively electrically connected to the inner end and the outer end.

In the third aspect, the present disclosure further provides an electronic device, comprising: a device body, having a coil installation space inside; and the coil assembly according to the second aspect, located within the coil installation space.

The present disclosure provides a wireless power transmission coil, a coil assembly, and an electronic device. By dividing the continuously wound wireless power transmission coil into a first section and a second section arranged along the circumferential direction, and employing different winding methods in the first and second sections, the first section has a first maximum thickness, and the second section has a second maximum thickness. The first section has a first width from the outer edge to the inner edge, and the second section has a second width from the outer edge to the inner edge. The second maximum thickness is greater than the first maximum thickness, and the second width is less than the first width.

### BRIEF DESCRIPTION OF THE DRAWINGS

FIG. 1 is a perspective view of a wireless power transmission coil according to an embodiment of the present disclosure;

FIG. 2 is a top view of a wireless power transmission coil according to an embodiment of the present disclosure;

FIG. 3 is a side view of a wireless power transmission coil according to an embodiment of the present disclosure;

FIG. 4 is a comparative schematic diagram of a wireless power transmission coil according to an embodiment of the present disclosure and a comparative coil according to a comparative embodiment;

FIG. 5 is an internal structure view of a wireless power transmission coil according to an embodiment of the present disclosure;

FIG. 6 is a cross-sectional view of a wireless power transmission coil according to an embodiment of the present disclosure;

FIG. 7 is a cross-sectional view of a wireless power transmission coil according to another embodiment of the present disclosure;

FIG. 8 is a cross-sectional view of a wireless power transmission coil according to another embodiment of the present disclosure;

FIG. 9 is a winding method illustration for a wireless power transmission coil according to an embodiment of the present disclosure;

FIG. 10 is a cross-sectional view of a wireless power transmission coil according to another embodiment of the present disclosure;

FIG. 11 is a cross-sectional view of a wireless power transmission coil according to another embodiment of the present disclosure;

FIG. 12 is a cross-sectional view of a wireless power transmission coil according to another embodiment of the present disclosure;

FIG. 13 is a partial view of the conductor used for winding the wireless power transmission coil according to an embodiment of the present disclosure;

FIG. 14 is a structural view of a coil assembly according to an embodiment of the present disclosure;

FIG. 15 is an internal structure view of an electronic device according to an embodiment of the present disclosure.

### DETAILED DESCRIPTION OF EMBODIMENTS

Several preferred embodiments of the present disclosure will be described in detail in conjunction with the accompanying drawings as follows, however, the present disclosure is intended to encompass any substitutions, modifications, equivalents, etc., made thereto without departing from the spirit and scope of the present disclosure. In order to provide those skilled in the art with thorough understanding of the present disclosure, particular details will be described below in the preferred embodiments of the present disclosure, although those skilled in the art can understand the present disclosure without the description of these details.

In addition, it should be understood by those skilled in the art that the accompanying drawings are provided herein for purposes of illustration and that the accompanying drawings are not necessarily to scale.

Furthermore, it should be understood that the terms “circuit” used herein refer to conductive circuits formed by at least one component or sub-circuit that are electrically or electromagnetically connected. When an element or circuit is referred to as “connected to” another element or “connected between” two nodes, it may be directly coupled or connected to another element or there may be intermediate elements, and the connection between elements may be physical, logical, or a combination thereof. Conversely, when an element is referred to as “directly coupled to” or “directly connected to” another element, it means that there are no intermediate elements between the two.

Unless otherwise specified and limited, the terms “mounted,” “connected,” “fixed,” and similar terms should be broadly understood, for example, they may be fixed connections or detachable connections, or integrated; they may be mechanical connections or electrical connections; they may be directly connected or indirectly connected through intermediate media, and can be an internal connection or interaction relationship between two elements, unless otherwise specified. To those skilled in the art, the specific meaning of the above terms in this disclosure may be understood on a case-by-case basis.

For ease of illustration, spatially relative terms such as “inside,” “outside,” “below,” “underneath,” “lower part,” “upper part,” “above,” etc., are used herein to describe the relationship between one component or feature and another component or feature in the drawings. It will be understood that spatially relative terms may encompass different orientations of the device during use or operation other than those depicted in the figures. For example, if the device in the figures is flipped, the component described as being “below” or “underneath” another component or feature will then be positioned as being “above” that other component or feature. Thus, the example term “below” may encompass both above and below orientations. The device may be oriented in other ways (rotated 90 degrees or in other orientations), and the spatially relative descriptive words used herein should be interpreted accordingly.

Unless the context clearly requires otherwise, the terms “include,” “comprise,” and similar terms throughout the specification should be interpreted as meaning “including but not limited to,” that is, they have an inclusive meaning rather than an exhaustive one.

In the description of the present application, it should be understood that the terms “first,” “second,” and so on are used for descriptive purposes only and should not be construed as indicating or implying relative importance. Furthermore, in the description of the present application, unless otherwise specified, the term “multiple” means two or more.

In the following description, the wireless charging device and method are described in the context of charging a mobile phone (i.e., the device to be charged). The device to be charged is an electronic device with functions such as data transmission, data processing, data storage, human-computer interaction, and wireless charging. It should be understood that the wireless charging device and method of the present disclosure may also be designed for various charging scenarios, and the device to be charged may also be a tablet computer, smart home devices, etc.

Electronic devices typically comprise multiple components. When the space for a wireless charging module is encroached upon by other components, an existing solution is to reduce the overall outer profile dimensions of the wireless power transmission coil to accommodate the internal space of the electronic device. For wireless power transmission coils manufactured by winding, one existing approach is to reduce the number of winding turns to decrease the outer profile dimensions of the wireless power transmission coil 1, for example, reducing the number of turns of a single-layer planar circular coil from 30 to 25 to reduce the outer profile diameter of the coil. However, this method significantly reduces the area of the wireless power transmission coil 1, which has a considerable negative impact on wireless charging power and efficiency.

The embodiments of the present disclosure provide a new wireless power transmission coil 1, which can be applied in electronic devices and is advantageous for maintaining wireless charging transmission efficiency when the internal space of the electronic device is limited.

The wireless power transmission coil 1 of the present disclosure is a multi-turn coil made by winding the conductor 10. The wireless power transmission coil 1 is continuously wound from the conductor 10 along a predetermined first winding direction, for example, the conductor 10 may be continuously wound around a mold core to form the wireless power transmission coil 1. The first winding direction may be a clockwise direction around the winding axis AX of the wireless power transmission coil 1, such as a clockwise or counterclockwise direction. The outer profile shape of the wireless power transmission coil 1 may be essentially circular, rectangular, triangular, trapezoidal, or other shapes, and may be specifically selected based on the size of the internal space of the electronic device, the distribution of various components, and the type of power transmitter.

The specific type of conductor 10 may be selected based on the actual needs of the electronic product, such as single-strand enameled wire, multi-strand enameled wire, Litz wire, or superconducting material wire, etc. In this embodiment, the conductor 10 may be a Litz wire. The Litz wire is composed of multiple individually insulated conductors twisted or woven together. The internal structure of the Litz wire may be described as a bundle of fine wires formed by multiple wires. This multi-strand refinement mode confines the skin effect in the magnetic field to the small area of the fine wires themselves, thereby reducing the internal impedance of the conductor 10. Using Litz wire to wind the wireless power transmission coil 1 is conducive to maintaining wireless charging efficiency. The conductor 10 can also be a self-bonding wire, which facilitates fixing and shaping the wound coil turns during the winding process.

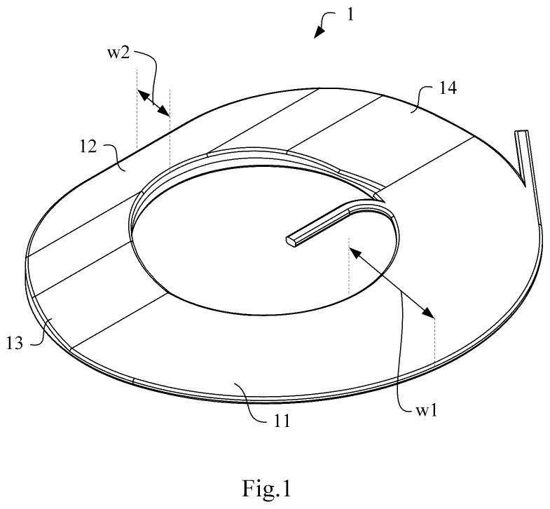

Referring to FIGS. 1 to 3, the wireless power transmission coil 1 has a first section 11 and a second section 12 arranged along the circumferential direction. The first section 11 has a first maximum thickness, and the second section 12 has a second maximum thickness. The wireless power transmission coil 1 has a hollow center. The first section 11 has a first width w1 from the outer edge to the inner edge of the wireless power transmission coil 1, and the second section 12 has a second width w2 from the outer edge to the inner edge of the wireless power transmission coil 1, the second maximum thickness is greater than the first maximum thickness, and the second width w2 is less than the first width w1. Optionally, the conductor 10 is a uniformly sized wire. The present disclosure, during the winding process, the conductor 10 is stacked with a smaller thickness and a larger first width w1 in the first section 11, resulting in a flatter profile for the first section 11; the conductor 10 is stacked with a relatively greater thickness in the second section 12, resulting in a relatively smaller second width w2. Thus, the first section 11 and the second section 12 of the wireless power transmission coil 1 have different cross-sectional shapes, which may fully adapt to the limited space within the electronic device, avoid interference with other components inside the device, and maintain the area of the wireless power transmission coil 1 to ensure wireless charging power and efficiency.

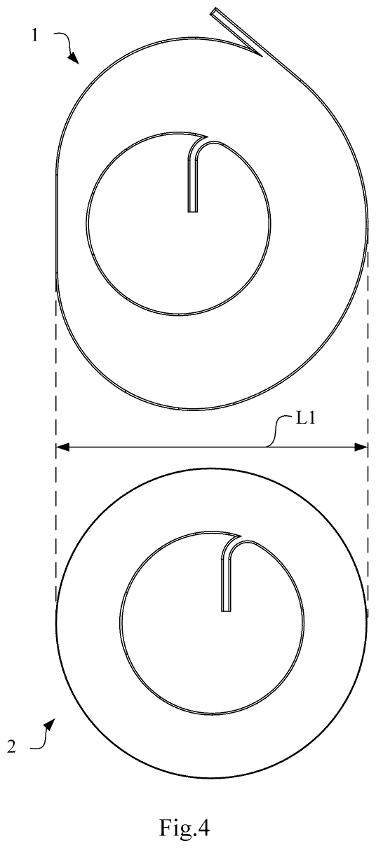

Referring to FIG. 4, the upper part of FIG. 4 is a top view of the wireless power transmission coil 1 according to the present disclosure, and the lower part of FIG. 4 is a top view of a comparative wound coil 2 of a comparative embodiment. The wound coil 2 in the comparative embodiment and the wireless power transmission coil 1 using the technical solution of the present disclosure have the same width L1 in the left-right direction to fit the narrower space in the electronic device along the left-right direction compared to the up-down direction. And the central shape of the coil in the upper part of FIG. 4 and the coil in the lower part of FIG. 4 is the same. As shown in FIG. 4, the wireless power transmission coil 1 according to the present disclosure has a larger area compared to the comparative wound coil 2, thereby ensuring wireless charging power.

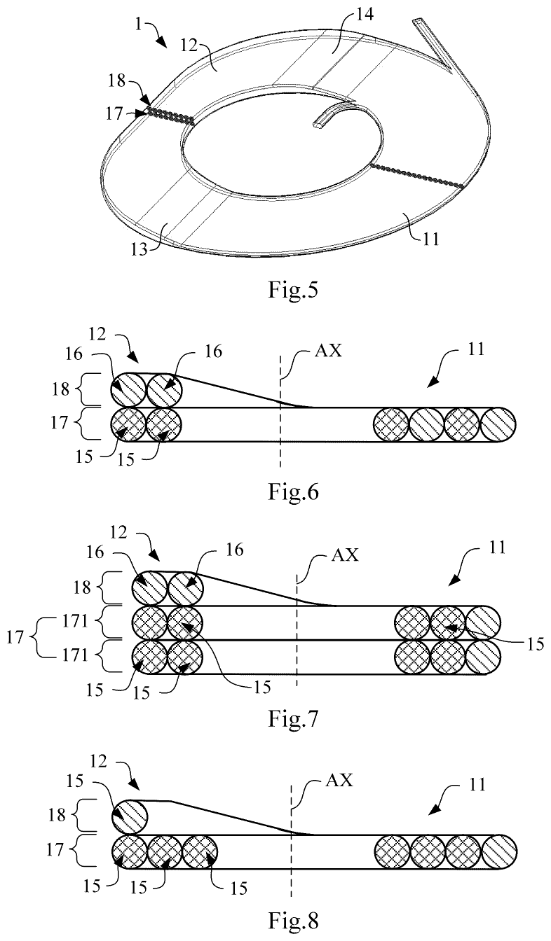

FIG. 5 schematically illustrates the positions of the coil turns of the wireless power transmission coil 1 in the first section 11 and the second section 12 according to the embodiment of the present disclosure. FIGS. 6 to 8 and FIGS. 10 to 12 show the cross-sections of the wireless power transmission coil 1 in different embodiments, and the cross-sections of the wireless power transmission coil 1 shown in FIGS. 6 to 8 and FIGS. 10 to 12 are taken through the plane passing through the first section 11, the second section 12, and the winding axis AX of the wireless power transmission coil 1. In one embodiment, referring to FIGS. 5 and 6, the wireless power transmission coil 1 includes a basic layer 17 and a superimposed layer 18, with the superimposed layer 18 located on one side of the basic layer 17 in the thickness direction. That is, the basic layer 17 and the superimposed layer 18 correspond to different height positions of the wireless power transmission coil 1. The wireless power transmission coil 1 includes multiple basic turns 15 and multiple interlayer turns 16, with the basic turns 15 and the interlayer turns 16 being alternately arranged in a certain manner. Among the multiple basic turns 15 of the wireless power transmission coil 1, there is at least one interlayer turn 16 between two adjacent basic turns 15 in a first winding direction. The basic turns 15 are wound only in the basic layer 17, while the interlayer turns 16 are wound through both the basic layer 17 and the superimposed layer 18. That is, different portions of the interlayer turns 16 are located at different height positions of the wireless power transmission coil 1. Specifically, the interlayer turns 16 are located in the basic layer 17 in the first section 11 and in the superimposed layer 18 in the second section 12. By providing the interlayer turns 16 and winding them in the superimposed layer 18 in the second section 12, the interlayer turns 16 is stacked in the second section 12 to increase the thickness of the wireless power transmission coil 1. This results in the wound wireless power transmission coil 1 with a smaller width in the first section 11 and a larger thickness, thereby adapting to the space constraints within the electronic device while ensuring that the area of the wireless power transmission coil is not excessively reduced, which may maintain the charging efficiency of wireless charging.

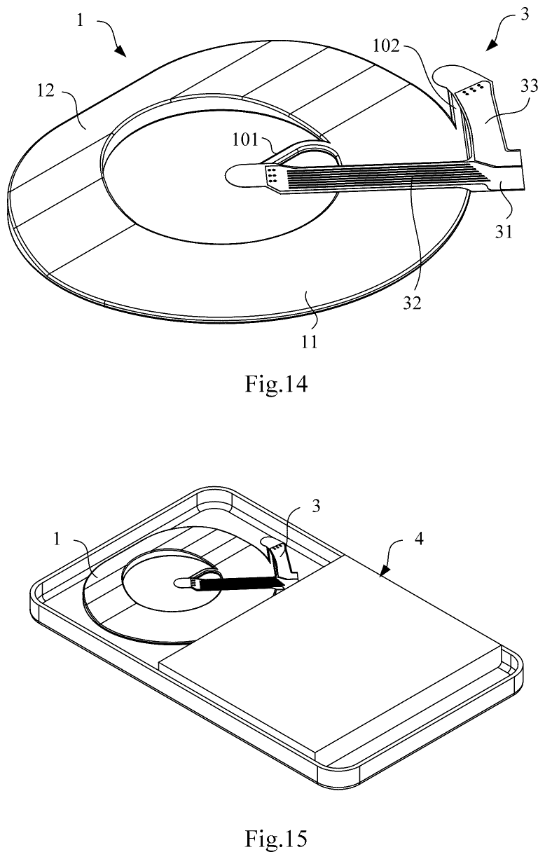

At various locations along the length direction SD of the conductor 10, the cross-sectional dimensions of the conductor 10 perpendicular to the length direction SD are substantially constant. FIG. 13 shows a schematic diagram of a portion of the conductor 10, and referring to FIG. 13, the length direction SD of the conductor 10 refers to the extending direction of the conductor 10. FIG. 13 illustrates a plane CRS perpendicular to the length direction SD of the conductor 10, with the cross-section of the conductor 10 perpendicular to the length direction SD being perpendicular to the plane of the drawing. When the conductor 10 is wound to form the wireless power transmission coil 1, the length direction SD of the conductor 10 is substantially parallel to the first winding direction. That is, the conductor 10 is a uniformly sized and shaped conductor, for example, the conductor 10 may be a Litz wire with a substantially constant outer diameter along the length direction SD. FIGS. 6 to 8 and FIGS. 10 to 12 show the cross-sectional shapes of the conductor 10 in the first section 11 and the second section 12. Referring to FIGS. 6 to 8 and 10, the cross-sectional shape of the conductor 10 in the first section 11 and the second section 12, as well as in other regions of the wireless power transmission coil 1, is a substantially equal circle. Referring to FIGS. 11 and 12, the cross-sectional shape of the conductor 10 in the first section 11 and the second section 12, as well as in other regions of the wireless power transmission coil 1, is a substantially equal rectangle. Thus, by adjusting the stacking of the turns of the conductor 10 in different regions of the wireless power transmission coil 1 during winding, the shape of the wireless power transmission coil 1 in the first section 11 and the second section 12 may be conveniently and accurately adjusted to match the shape of the space in which it is to be installed.

Furthermore, referring to FIGS. 1, 2, and 5, the wireless power transmission coil 1 also includes a first transition section 13 and a second transition section 14. The first section 11, the first transition section 13, the second section 12, and the second transition section 14 are sequentially connected end-to-end along the circumferential direction of the wireless power transmission coil 1 to form a complete coil structure. Each turn of the conductor 10 during winding passes through the first section 11, the first transition section 13, the second section 12, and the second transition section 14. Referring to FIGS. 6 to 10, the basic turns 15 are located in the basic layer 17 in the first section 11, the first transition section 13, the second section 12, and the second transition section 14; the interlayer turns 16 enter the superimposed layer 18 from the basic layer 17 in the first transition section 13 along the first winding direction, and enter the basic layer 17 from the superimposed layer 18 in the second transition section 14 along the first winding direction.

The basic layer 17 has a substantially uniform thickness. The basic layer 17 may include a single layer or multiple layers of the conductor 10, which can be specifically selected based on the size of the conductor 10, the available space within the electronic device, and the requirements for wireless power transmission performance. In some embodiments, referring to FIGS. 6 and 8, the basic layer 17 includes a single layer of the conductor 10, allowing the first section 11 to have a smaller first maximum thickness to adapt to the limited height space within the electronic device. In other embodiments, referring to FIG. 7, the basic layer 17 includes at least two sub-basic layers 171 stacked sequentially in the thickness direction of the wireless power transmission coil 1, with each sub-basic layer 171 having a single layer of the conductor 10, and each basic turn 15 is wound within the same sub-basic layer 171. The shapes of the sub-basic layers 171 may be substantially the same, for example, multiple sub-basic layers 171 may be identical annular shapes.

In some embodiments, referring to FIGS. 6 and 8, the superimposed layer 18 includes a single layer of the conductor 10, while the basic layer 17 includes a single layer of the conductor 10. Thus, the wireless power transmission coil 1 has a single layer of the conductor 10 in the first section 11 and two layers of the conductor 10 in the second section 12. By adjusting the ratio of interlayer turns 16 to basic turns 15, the second width w2 can be regulated. For example, comparing FIGS. 6 and 8, when the total number of winding turns of the wireless power transmission coil 1 is constant, and the cross-sectional dimensions of the conductor 10 and the hollow center of the coil are the same, the number of interlayer turns 16 in FIG. 6 is greater than that in FIG. 8, consequently, the second width w2 of the second section 12 in FIG. 6 is smaller than that in FIG. 8, while the first width w1 of the first section 11 remains the same in both FIGS. 6 and 8. When the winding of the wireless power transmission coil 1 alternates between one basic turn 15 and one interlayer turn 16, the second width w2 of the second section 12 has a smaller value.

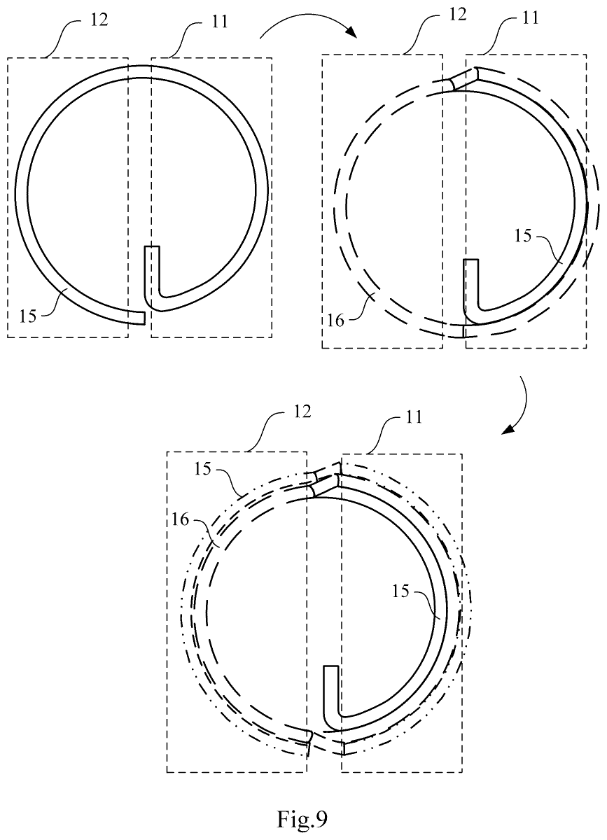

FIG. 9 is a schematic illustration of the winding process of the wireless power transmission coil 1 according to the embodiment of the present disclosure. Referring to FIG. 9, taking the winding of the conductor 10 in the counterclockwise direction as an example, there is one interlayer turn 16 between two basic turns 15. After the first basic turn 15 is wound from the first section 11 to the second section 12 in the basic layer 17 (as shown in the upper left corner of FIG. 9), the conductor 10 continues to the first section 11 in the basic layer 17 to start the winding of the interlayer turn 16 (indicated by the dashed contour in the upper right corner of FIG. 9). When the interlayer turn 16 is wound to the second section 12, the conductor 10 moves to the superimposed layer 18 to be stacked on one side of the basic layer 17 (the side facing outward from the plane of the drawing). Referring to the lower part of FIG. 9, the conductor 10 is then continued to the basic layer 17 and wound counterclockwise sequentially in the first section 11 and the second section 12 to form the second basic turn 15 (indicated by the double-dashed line). The second basic turn 15 is located outside the interlayer turn 16 in the first section 11 and outside the first basic turn 15 in the second section 12. In this way, a wireless power transmission coil 1 with different widths and thicknesses in the first section 11 and the second section 12 is formed.

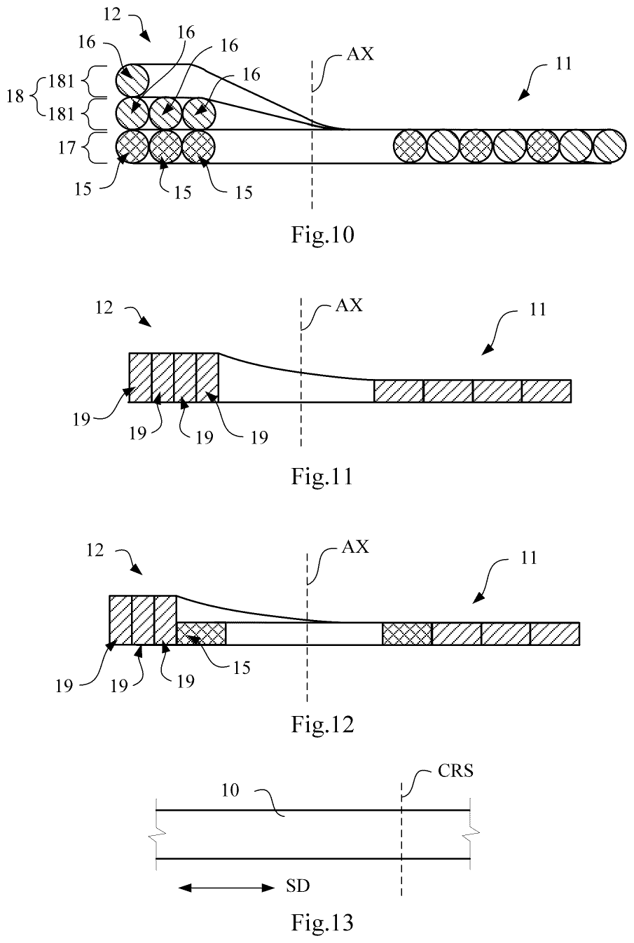

In some embodiments, referring to FIG. 10, the superimposed layer 18 includes at least two sub-superimposed layers 181, each of which has a single layer of the conductor 10. The at least two sub-superimposed layers 181 are stacked sequentially on one side of the basic layer 17 in the thickness direction, and each interlayer turn 16 is located in the same sub-superimposed layer 181 in the second section 12. The wireless power transmission coil 1 has at least two continuously arranged interlayer turns 16, and two adjacent interlayer turns 16 are located in adjacent sub-superimposed layers 181 in the second section 12. For example, referring to FIG. 10, the superimposed layer 18 includes two sub-superimposed layers 181, namely the first sub-superimposed layer 181 and the second sub-superimposed layer 181. The first sub-superimposed layer 181 is in contact with one surface of the basic layer 17, and the second sub-superimposed layer 181 is located on the surface of the first sub-superimposed layer 181 that is away from the basic layer 17. The interlayer turns 16 of the wireless power transmission coil 1 in FIG. 10 are divided into two types: the first interlayer turn 16 and the second interlayer turn 16. The first interlayer turn 16 is wound on the first sub-superimposed layer 181 in the second section 12, and the second interlayer turn 16 is wound on the second sub-superimposed layer 181 in the second section 12. Moreover, there is a first interlayer turn 16 between the second interlayer turn 16 and the preceding basic turn 15, that is, the second interlayer turn 16 is located on the outer side of the first interlayer turn 16 (the side away from the winding axis AX of the wireless power transmission coil 1) in the first section 11 and is stacked on top of the first interlayer turn 16 in the second section 12.

In other embodiments, the cross-section of the conductor 10 perpendicular to the length direction SD has a long side and a short side, with the long side being substantially perpendicular to the short side. For example, the cross-section of the conductor 10 perpendicular to the length direction SD may be approximately rectangular (as shown in FIGS. 11 and 12), elliptical, etc. The wireless power transmission coil 1 includes at least one twist turn 19, the conductor 10 of the twist turn 19 is twisted in the first transition section 13 and the second transition section 14, thereby adjusting the position of the long side and the short side of the conductor 10 relative to the axis of the wireless power transmission coil 1 during winding. This results in the long side of the twist turn 19 being substantially perpendicular to the axis of the wireless power transmission coil 1 in the first section 11, and the short side being substantially perpendicular to the axis in the second section 12. Consequently, the width of the first section 11 is less than that of the second section 12. In one implementation, as shown in FIG. 11, the wireless power transmission coil 1 is composed of multiple twist turns 19, and the width of the first section 11 is the sum of the dimensions of multiple short sides. In another implementation, as shown in FIG. 12, the wireless power transmission coil 1 also includes at least one basic turn 15, the long side of the twist turn 19 is substantially perpendicular to the axis of the wireless power transmission coil 1. By properly configuring the ratio of the number of basic turns 15 to the number of twist turns 19, the ratio between the first width w1 and the second width w2 is available to be adjusted.

Taking the wireless power transmission coil 1 in the shape of an approximate annulus as an example, Table 1 below shows the comparison of dimensions and charging efficiency of the wireless power transmission coil 1 under different ratios of the first width w1 to the second width w2 according to the embodiments of the present disclosure:

TABLE 1

| Ratio of First | Reduction Rate | | |
|---|---|---|---|
| Width w1 to | in Y- | Reduction | Charging |
| Second Width w2 | Direction Size | Rate in Area | Efficiency |
| 1:1 | 1 | 0 | 85% |
| 2:1 | 12.5% | 20% | 83% |
| 3:1 | 16.6% | 26% | 82% |
| 4:1 | 18.75% | 29% | 81% |

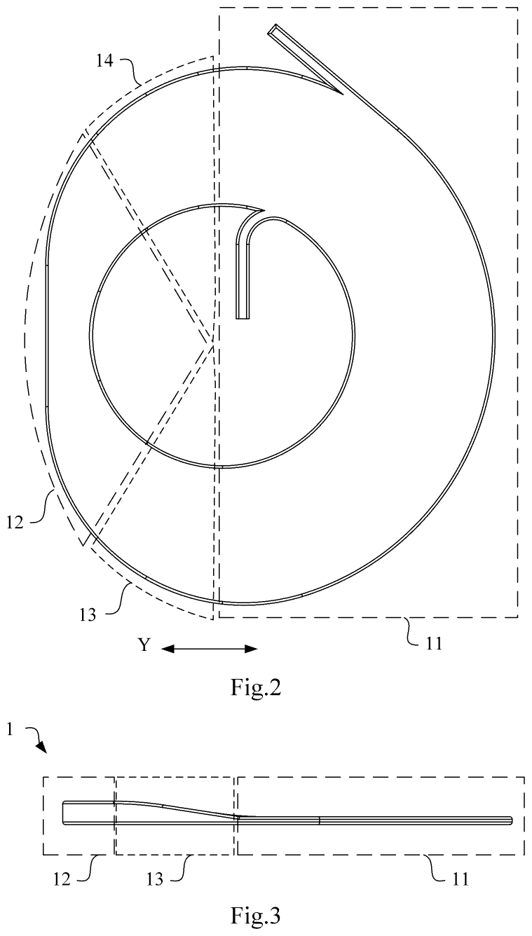

The Y-direction dimension in Table 1 refers to the shortest dimension in the direction perpendicular to the axis of the wireless power transmission coil 1, such as the dimension from the leftmost to the rightmost end of the wireless power transmission coil 1 in FIG. 2. As shown in the table, compared with the uniform-width annular coil (where the ratio of the first width w1 to the second width w2 is 1:1), the wireless power transmission coil 1 according to the embodiments of the present disclosure is effectively reduce the Y-direction dimension to fit the space within the electronic device while maintaining a relatively small reduction in the overall area of the wireless power transmission coil 1, thereby ensuring the charging efficiency of wireless charging.

The embodiments of the present disclosure also provide a coil assembly, which is applicable in wireless charging systems and may be used as part of the wireless power transmission circuit at the power transmitter end or as part of the wireless power reception circuit at the power receiver end. FIG. 14 is a schematic illustration of the coil assembly according to the embodiments of the present disclosure. Referring to FIG. 14, the coil assembly includes a connection circuit board 3 and the wireless power transmission coil 1 described in at least some of the above embodiments. The connection circuit board 3 is equipped with a connection circuit that electrically connects the wireless power transmission coil 1 to other components, for example, for the power receiver end, the wireless power transmission coil 1 may be electrically connected to a rechargeable battery through the connection circuit on the connection circuit board 3, thereby enabling the transmission of received electrical energy to the rechargeable battery. By using the wireless power transmission coil 1 described in at least some of the above embodiments, the coil assembly may fully adapt to the limited space or irregular spaces within the electronic device that are occupied by other components, moreover, the wireless power transmission coil 1 has a larger area, which ensures the efficiency and power of wireless charging.

The connection circuit board 3 may be a rigid printed circuit board, a flexible printed circuit board (FPC), or a rigid-flex printed circuit board. The shape and positioning of the connection circuit board 3 may be determined based on the internal space of the electronic device and the positions of other components. When the space within the electronic device is limited, the connection circuit board 3 may be a flexible printed circuit board, which has a smaller thickness and is easy to bend according to the shape of the internal space of the electronic device.

In one embodiment, the connection circuit board 3 includes a main body 31, a first connection arm 32, and a second connection arm 33. The first connection arm 32 and the second connection arm 33 extend outward from the main body 31. The first connection arm 32 extends to the inner end 101 and is connected to the inner end 101, while the second connection arm 33 extends to the outer end 102 and is connected to the outer end 102. This arrangement facilitates the electrical connection between the connection circuit on the connection circuit board 3 and the inner end 101 and the outer end 102. It also eliminates the need to route both ends of the conductor 10 to the outside of the wireless power transmission coil 1, simplifying manufacturing and promoting a compact design. The first connection arm 32 and the second connection arm 33 may be set at a certain angle relative to each other as needed, to fully adapt to the shape of the wireless power transmission coil 1 and the internal space layout of the electronic device.

In one embodiment, the inner end 101 and the outer end 102 are located in the first section 11, the first connection arm 32 and the second connection arm 33 are positioned on one side surface of the first section 11 and avoid the second section 12. Since the first section 11 has a thinner thickness, the first connection arm 32 and the second connection arm 33 may be placed at a position corresponding to the first section 11 to fully utilize the height space.

The present disclosure also provides an electronic device, which may be a mobile phone, tablet computer, smartwatch, in-vehicle terminal, or any other electronic device that requires wireless charging functionality. Referring to FIG. 15, the electronic device according to the present disclosure includes a device body 4 and the coil assembly described in at least some of the above embodiments. The device body 4 includes a coil installation space, and the coil assembly is located within this installation space. By using the coil assembly described in at least some of the above embodiments, the coil installation space can be fully utilized. Even when the coil installation space is limited or occupied by other components, the area of the wireless power transmission coil 1 can be maintained, thereby ensuring the charging efficiency of wireless charging.

The foregoing descriptions of specific embodiments of the present disclosure have been presented for purposes of illustration and description. They are not intended to be exhaustive or to limit the present disclosure to the precise forms disclosed, and obviously, many modifications and variations are possible in light of the above teaching. The embodiments were chosen and described in order to best explain the principles of the present disclosure and its practical application, thereby enable others skilled in the art to best utilize the present disclosure and various embodiments with various modifications as are suited to the particular use contemplated. It is intended that the scope of the present disclosure be defined by the claims appended hereto and their equivalents.

I/We claim:

1. A wireless power transmission coil, wherein the wireless power transmission coil is continuously wound from a conductor in a first winding direction, the wireless power transmission coil has a first section and a second section arranged along the circumferential direction, the first section has a first maximum thickness, the second section has a second maximum thickness, the first section has a first width from the outer edge to the inner edge, and the second section has a second width from the outer edge to the inner edge, wherein the second maximum thickness is greater than the first maximum thickness and the second width is less than the first width.

2. The wireless power transmission coil according to claim 1, wherein, in the length direction of the conductor, the cross-sectional dimension of the conductor perpendicular to the length direction is constant.

3. The wireless power transmission coil according to claim 1, wherein the wireless power transmission coil further has a first transition section and a second transition section, the first section, the first transition section, the second section, and the second transition section are connected end-to-end along the circumferential direction of the wireless power transmission coil.

4. The wireless power transmission coil according to claim 3, wherein the wireless power transmission coil comprises a plurality of basic turns and a plurality of interlayer turns, at least one of the interlayer turns is connected between two adjacent basic turns in the first winding direction, the wireless power transmission coil has a basic layer and a superimposed layer, the superimposed layer is located on one side of the basic layer in a thickness direction;
wherein the basic turns are located in the basic layer;
the interlayer turns are located in the basic layer in the first section, and are located at least in the superimposed layer in the second section;
the interlayer turns enter the superimposed layer from the basic layer in the first transition section along the first winding direction, and enter the basic layer from the superimposed layer in the second transition section along the first winding direction.

5. The wireless power transmission coil according to claim 4, wherein the superimposed layer comprises at least two sub-superimposed layers, each sub-superimposed layer has a single layer of the conductor, the at least two sub-superimposed layers are stacked sequentially on one side of the basic layer in the thickness direction, the wireless power transmission coil has at least two continuously arranged interlayer turns, each interlayer turn is located in the same sub-superimposed layer in the second section, and two adjacent interlayer turns are located in adjacent sub-superimposed layers in the second section.

6. The wireless power transmission coil according to claim 4, wherein the basic layer has a single layer of the conductor; or
the basic layer comprises at least two sub-basic layers, each sub-basic layer has a single layer of the conductor, the shapes of the at least two sub-basic layers are the same, the at least two sub-basic layers are stacked sequentially in the thickness direction of the wireless power transmission coil, and each basic turn is located in the same sub-basic layer.

7. The wireless power transmission coil according to claim 3, wherein the cross-section of the conductor perpendicular to the length direction has a long side and a short side, the long side is perpendicular to the short side, the wireless power transmission coil comprises at least one twist turn, the long side of the twist turn is perpendicular to the axis of the wireless power transmission coil in the first section, and the short side of the twist turn is perpendicular to the axis of the wireless power transmission coil in the second section;
the conductor of the twist turn is twisted in the first transition section and the second transition section.

8. The wireless power transmission coil according to claim 7, wherein the wireless power transmission coil further comprises at least one basic turn, and the long side of the twist turn is perpendicular to the axis of the wireless power transmission coil.

9. The wireless power transmission coil according to claim 1, wherein the conductor is a Litz wire or a self-bonding wire.

10. A coil assembly, comprising:
a wireless power transmission coil according to claim 1, the conductor of the wireless power transmission coil has an inner end and an outer end; and
a connection circuit board, located on one side of the wireless power transmission coil and respectively electrically connected to the inner end and the outer end.

11. The coil assembly according to claim 10, wherein the connection circuit board has a main body, a first connection arm, and a second connection arm, the first connection arm extends from the main body to the inner end and is connected to the inner end, and the second connection arm extends from the main body to the outer end and is connected to the outer end.

12. The coil assembly according to claim 11, wherein the inner end and the outer end are located in the first section, and the first connection arm and the second connection arm are located on one side of the first section and avoid the second section.

13. The coil assembly according to claim 10, wherein the connection circuit board is a rigid printed circuit board, a flexible printed circuit board, or a rigid-flex printed circuit board.

14. An electronic device, comprising:
a device body having a coil installation space inside; and
a coil assembly, located within the coil installation space, wherein the coil assembly comprises:
a wireless power transmission coil according to claim 1, the conductor of the wireless power transmission coil has an inner end and an outer end; and
a connection circuit board, located on one side of the wireless power transmission coil and respectively electrically connected to the inner end and the outer end.
